(19) United States
(12) Patent Application Publication
(10) Pub. No.: US 2009/0206768 A1
(43) Pub. Date: Aug. 20, 2009

(54) METHOD AND DEVICE FOR DRIVING A LAMP

(75) Inventors: Petrus Johannes Bremer, Eindhoven (NL); Wilhelmus David Ettes, Leeuwarden (NL); Alexander Christaan De Rijck, Waarle (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/303,261

(22) PCT Filed: May 9, 2007
(86) PCT No.: PCT/IB07/51757

§ 371 Date: Dec. 3, 2008

Related U.S. Application Data
(60) Provisional application No. 60/804,287, filed on Jun. 9, 2006.

(51) Int. Cl. H05B 37/02

(52) U.S. Cl. 315/287

(57) ABSTRACT

A method is described for driving a lamp with a periodic signal (L) having a frame period (t13−t11), the periodic signal (L) being a block-shaped signal during an ON-interval (t11 to t12) of said frame period and being zero during an OFF-interval (t12 to t13) of said frame period.

Said block-shaped signal has a duty cycle of 50% and a block period (t22−t11) smaller than said frame period. The duration (t12−t11) of said ON-interval (t11 to t12) of said frame period is equal to an integer number times said block period (t22−t11).

According to the invention, the beginning (t11) of said ON-interval (t11 to t12) of said frame period coincides with a phase 90° of said block-shaped signal.

### FIELD OF THE INVENTION

The present invention relates in general to a device for driving a lamp, especially a device for driving a fluorescent gas discharge lamp.

### BACKGROUND OF THE INVENTION

Lamps in general have a nominal rating, i.e. nominal operational voltage and current providing a nominal light output. In general, there is a need for being able to operate a lamp in a dimmed mode, such that the actual light output is less than nominal.

Dimming can be achieved by reducing the lamp current, but in the case of gas discharge lamps it is also known to drive the lamps in a switched mode (alternating ON/OFF) with variable duty cycle. During the ON periods, the lamp receives nominal power; during the OFF periods, the lamp receives no power. If the ON/OFF switching frequency is high enough (at least above 20 Hz), the resulting light output is the timeaverage of the light output during the ON periods and the light output during the OFF periods. This average depends on the duty cycle A, defined as Δ=t_{ON}/(t_{ON}+t_{OFF}).

As an example of an application, the backlighting of an LCD panel is mentioned. For backlighting of an LCD panel, for use in an LCD TV or an LCD monitor, it is known to arrange an array of horizontal fluorescent lamps behind the LCD. An LCD driver receives image signals, and controls the LCD cells to be transparent, partly transparent, or not transparent, i.e. to pass the lamp light or not. The LCD cells thus define image pixels. In a bright portion of the image, the LCD cells are transparent so that the lamp light passes and the corresponding image pixels are bright. In a dark portion of the image, the LCD cells are opaque so that the lamp light is blocked and the corresponding image pixels are dark. In this way, a contrast ratio of approximately 1:200 to 1:500 can be achieved. For good picture quality, however, a contrast ratio of at least 1:1200 or preferably even 1:1800 is desirable. This further increase in the contrast ratio can be provided by dimming the lamps. A lamp dimming controller switches the lamps ON and OFF on the basis of the image signals. Thus, in a backlight system for LCD TV or LCD monitors, the lamps are typically operated with a switching frequency equal to the frame frequency (typically between 50 Hz and 125 Hz, depending on the setting of the apparatus concerned), and a duty cycle varies in a typical range from 2% to 20%, although the duty cycle may even be set as high as 40%. In such situation, the ON time can vary from 0.16 ms (2% duty cycle at 125 Hz) to 4 ms (20% duty cycle at 50 Hz) or more.

During the ON periods, the current in the fluorescent lamps is not a DC current but the current has a high-frequency current component from an oscillator, the frequency being typically in the order of 20-200 kHz, more typically in the order of about 50 kHz. This frequency shall be indicated as HF current frequency, in contrast to the LF lamp frequency=frame frequency. Thus, during an ON period, the lamp receives a limited number of HF current cycles. In a situation of 2% duty cycle, this number of HF current cycles would be 20 for a lamp frequency of 50 Hz and a HF current frequency of 50 kHz; for higher lamp frequencies, this number would be even lower.

The oscillator generating the HF current cycles typically comprises a timer controller and a transformer. The timer controller generates a symmetric block signal that can have two signal values “high” and “low”. The actual sine-shaped lamp current is provided by the transformer, but the timing of the sine-shaped lamp current is controlled by the timer block signal.

A lamp driver further typically comprises a duty cycle controller, providing a dimming command signal, also indicated as duty cycle command signal, that determines ON/OFF switching of the lamp at the LF lamp frequency. Normally, this duty cycle command signal and the HF block signal are independent from each other. In such case, the current conditions of the lamp at the moment of switching the lamp ON or OFF are not known in advance, and may vary from one lamp cycle to the next. This is undesirable, because noticeable lamp flicker may occur, which is annoying to the user. The lower the duty cycle, the more noticeable such flicker effect will be.

It is also possible to effect a fixed timing relationship between the lamp switching signals and the HF current cycles. For instance, it is possible to provide synchronization between the oscillator output frequency and the lamp switching frequency, using a PLL. In such case, the moment of switching the lamp ON will typically coincide with the start of a HF current cycle (i.e. rising edge of the HF block signal).

When the block signal is “high”, the transformer is charged; when the block signal is “low”, the transformer is discharged. Thus, in a complete HF cycle, the magnetic charge condition of the transformer rises from zero to a first maximum value (during “high” block signal) and then decreases back to zero (during “low” block signal). In the next HF cycles, this is repeated. As a consequence, the average magnetic charge condition is above zero, and the first maximum value of the magnetic charge condition is relatively high. As a result, saturation may occur, causing an unstable light output. In order to prevent saturation effects, the transformer must be dimensioned relatively large, leading to increased costs. Furthermore, if the transformer is DC coupled and directly driven, it may slowly drift to saturation within one lamp cycle.

A solution known in prior art to prevent such relatively high charge states is a so-called slow-start mechanism, where the duty cycle is only changed gradually. This can, however, not be applied, or only with great difficulty, in a system where the ON-times are relatively short.

In general, the present invention aims to provide a solution to the above problems.

### SUMMARY OF THE INVENTION

According to an important aspect of the present invention, a lamp is switched ON at a first moment in time which has a fixed timing relationship of 90° with the HF block signal, and the lamp driver is switched ON at a second moment in time which also has a fixed timing relationship of 90° with the HF block signal. A timing relationship of 90° with the HF block signal means that the “high” portion of the HF block signal is half-way. The transformer is charged during the remainder half of the “high” portion of the HF block signal, i.e. from phase 90° to phase 180°, to reach a second maximum value of the magnetic charge condition. During the first half of the “low” portion of the HF block signal, i.e. from phase 180° to phase 270°, the transformer is discharged so that the magnetic charge condition reaches zero, and then during the remainder half of the “low” portion of the HF block signal, i.e. from phase 270° to phase 360°, the transformer is further discharged to reach a minimum value, or better said a third maximum value of the magnetic charge condition which has opposite direction as compared with the second maximum value. Finally, during the first half of the next “high” portion of the HF block signal, i.e. from phase 0° to phase 90°, the charge condition rises to zero, after which the above is repeated. As a result, the average of the charge condition is always zero, and the peak values of the magnetization (i.e. the second and third maximum values) are lower than the first maximum value mentioned earlier.

### BRIEF DESCRIPTION OF THE DRAWINGS

These and other aspects, features and advantages of the present invention will be further explained by the following description with reference to the drawings, in which same reference numerals indicate same or similar parts, and in which:

FIG. 1 schematically shows a block diagram of an exemplary embodiment of a lamp driver according to the present invention;

FIGS. 2-4 are graphs schematically illustrating the timing of various signals in the lamp driver according to FIG. 1;

FIG. 5 is a flow diagram schematically illustrating an example of the operation of the lamp driver;

FIG. 6 is a block diagram schematically illustrating a variation of the lamp driver according to the present invention.

### DETAILED DESCRIPTION OF THE INVENTION

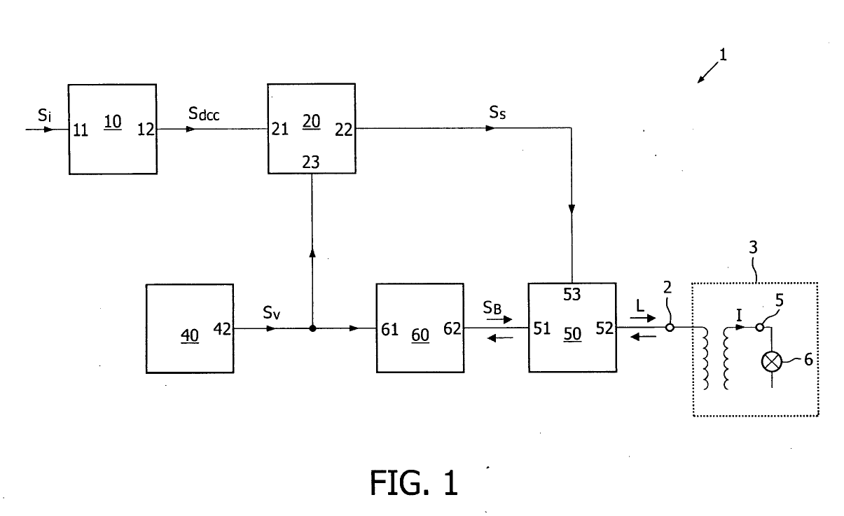

FIG. 1 schematically shows a block diagram of an exemplary lamp driver 1 according to the present invention, having an output 2 for connection to a lamp circuit 3. At its output 2, the lamp driver 1 outputs a lamp driving signal L. The lamp circuit 3 comprises a transformer 4, having its primary winding coupled to the output 2, and having its secondary winding coupled to a transformer output 5, to which a lamp 6 is connected. As will be explained, the lamp driving signal L is a block signal whereas the transformer output current I received by the lamp 6 is a sine-shaped signal. It is noted that the transformer 4 may be integrated in the lamp driver 1, in which case output 5 is the driver output while signal L is an internal signal.

The lamp driver 1 comprises a lamp dimming controller 10, having an input 11 receiving image signals Si, and having an output 12 outputting a dimming control signal Sdcc. The image signal Si contains horizontal and vertical timing information for an image, and also contains pixel information. On the basis of this image signal Si, the lamp dimming controller 10 calculates a dim level for the driven lamp, and thus calculates a duty cycle for this lamp. Based on this duty cycle, the dimming control signal Sdcc contains timing information for switching the lamp ON and OFF in synchronization with the image signal Si. In this exemplary embodiment, the dimming control signal Sdcc is a two-level signal, wherein a HIGH level indicates LAMP ON and wherein a LOW level indicates LAMP OFF.

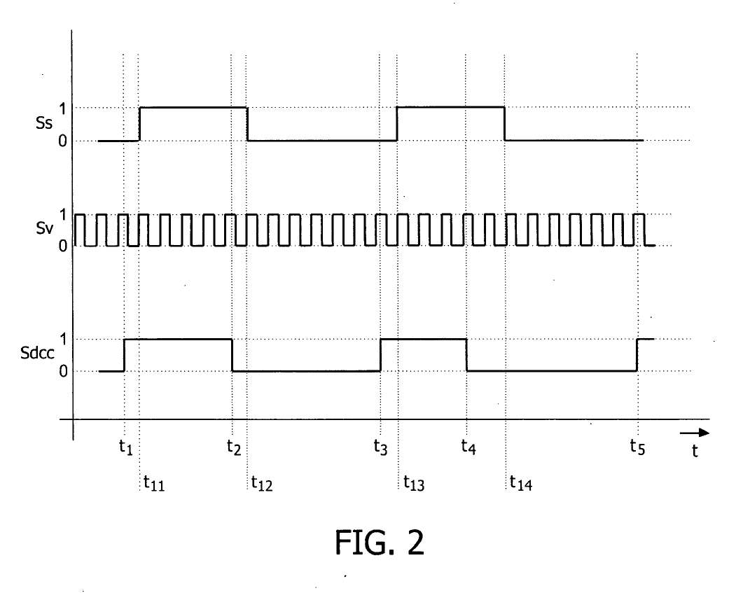

FIG. 2 illustrates that the dimming control signal Sdcc contains timing information determining that a lamp controlled by the lamp driver 1 should be switched ON on time t1 and should be switched OFF on time t2, and should be switched ON again on time t3, to result in a duty cycle Δ=(t2−t1)/(t3−t1). It is noted that this is the timing intended by the lamp dimming controller 10, and the switch times t1 and t2 will therefore also be indicated as “target” times; as will be explained, the actual switching may occur at different times.

The lamp driver 1 further comprises an oscillator 40 having an output 42 providing a high-frequency oscillator signal Sv, also illustrated in FIG. 2. This output 42 is coupled to an input 61 of a bridge circuit 60. The bridge circuit 60 may be a half-bridge of a full-bridge. Since bridge circuits are known per se, it is not necessary to explain the design of the bridge circuit 60 in great detail. It suffices to note that the bridge circuit 60 has an output 62 providing an output current SB which has either a positive direction or a negative direction (indicated by the double arrow) depending on the level of the oscillator signal Sv. By way of example, it is assumed that the bridge output current SB is positive (sourced from 62) when the oscillator signal Sv is HIGH, and that the bridge output current SB is negative (sinked into 62) when the oscillator signal Sv is LOW.

The bridge output 62 is connected to an input 51 of a controllable switch 50, whose output 52 is connected to the device output 2. The controllable switch 50 has two operative states. In a first operative state CLOSED, the switch 50 is conductive and passes signals received at its input 51 to its output 52; in this state, the lamp driving signal L follows the alternating current SB and a driven lamp is ON. In a second operative state OPEN, the switch 50 is non-conductive and blocks all incoming signals received at its input 51; in this state, the lamp driving signal L is zero and a driven lamp is OFF. Thus, switching the driven lamp ON and OFF is practiced by switching the controllable switch 50 to its CLOSED and OPEN states, respectively.

The lamp driver 1 further comprises a lamp switching controller 20, having an input 21 coupled to the output 12 of the lamp dimming controller 10 in order to receive the dimming control signal Sdcc, and having a control output 22 coupled to a control terminal 53 of the switch 50. The lamp switching controller 20 is designed to generate at its control output 22 a switch control output signal Ss for determining the operative state of the controllable switch 50. For convenience sake, it will be assumed that the switch control output signal Ss is a two-level signal, wherein a HIGH value of the switch control output signal Ss determines the switch's CLOSED state and wherein a LOW value of the switch control output signal Ss determines the switch's OPEN state, respectively.

It is noted that the bridge circuit 60 and the switch 50 may be integrated to form a switched bridge.

In a prior art device, the dimming command signal Sdcc would be coupled directly to the control terminal 53 of the switch 50. In such case, the driven lamp would be switched ON and OFF at the times t1 and t2, which have a random phase relation with the oscillator output signal Sv, as shown in FIG. 2. In the present invention, the lamp switching controller 20 is arranged between the lamp dimming controller 10 and the controllable switch 50. The lamp switching controller 20 is designed to generate its output control signal Ss on the basis of the dimming command signal Sdcc received at its first input and the oscillator output signal Sv received at a second input 23. More particularly, after time t1 when the dimming command signal Sdcc makes a transition from LOW to HIGH, the lamp switching controller 20 waits until the oscillator output signal Sv has a first predetermined phase on t11, and only then makes its output control signal Ss HIGH, as illustrated in FIG. 2. Thus, the driven lamp 6 is always switched ON in a predetermined phase relationship with the oscillator signal Sv, without a true synchronization between the lamp switching signal and the oscillator signal being required.

In a similar manner, after time t2 when the dimming command signal Sdcc makes a transition from HIGH to LOW, the lamp switching controller 20 may wait until the oscillator output signal Sv has a second predetermined phase on t12, and only then makes its output control signal Ss LOW. Thus, the driven lamp is always switched OFF in a predetermined phase relationship with the oscillator signal Sv, without a true synchronization between the lamp switching signal and the oscillator signal being required.

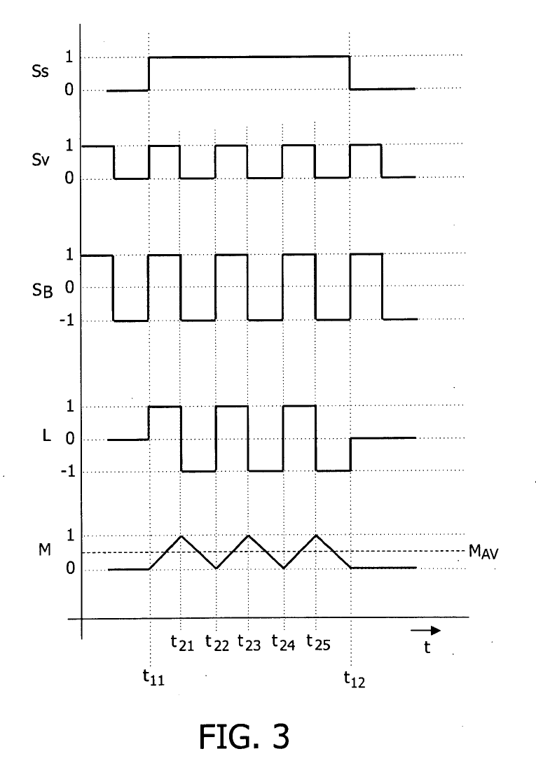

FIG. 3 is a graph illustrating several signals on a larger time scale. The first signal is the switch control signal Ss, defining the lamp ON period from time t11 to time t12. The second signal is the oscillator output signal Sv, alternating between 1 and 0. The third signal is the bridge output signal SB, alternating between positive and negative current, indicated as +1 and −1, respectively. It is noted that the bridge output signal SB is in phase with the oscillator output signal Sv. The fourth signal is the lamp driving signal L which, from time t11 to time t12, corresponds to the bridge output signal SB, and which is zero outside this time range. The fifth signal shown in FIG. 3 indicated the magnetic charge M of the transformer 4.

In the situation shown in FIG. 3, the first predetermined phase of the oscillator output signal Sv is the transition from LOW to HIGH, i.e. the beginning t11 of the ON interval (t11 to t12) coincides with a rising edge of the oscillator output signal Sv; this will be indicated as phase angle 0°. Likewise, the second predetermined phase of the oscillator output signal Sv is equal to 0°, so that the duration of the ON interval (t12−t11) of the output control signal Ss of the lamp switching controller 20 always is an integer multiple of the period of the oscillator signal Sv. It can be seen that the magnetic charge M rises from 0 to maximum (indicated as “1”) from phase 0° (t11) to phase 180° (t21), and returns to zero from phase 180° (t21) to phase 360° (t22). The magnetic charge M has an average MAV unequal to zero (this average would be equal to 0.5 in the notation of FIG. 3).

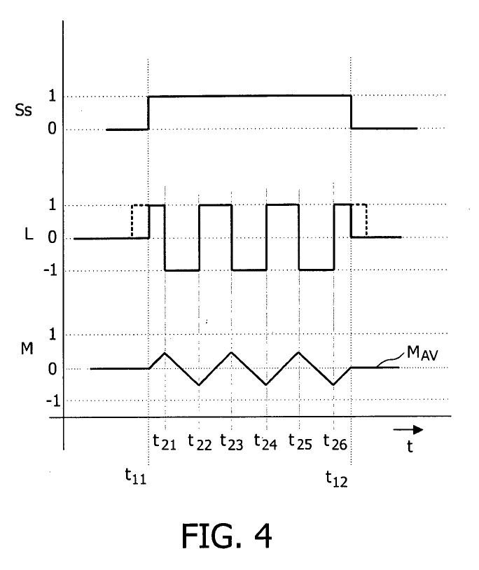

FIG. 4 is a graph comparable to FIG. 3, illustrating several signals in the device according to the present invention; the signals Sv and SB are omitted in FIG. 4. In this case, the beginning t11 of the ON interval coincides with a phase angle 90° of the oscillator output signal Sv. Thus, when the lamp drive signal L goes high on time t11, the time until the next falling edge of the oscillator output signal Sv (time t21) corresponds to 25% of the period of the oscillator output signal Sv. During this time, the magnetic charge M rises from 0 to a maximum of about 0.5 from phase 90° (t11) to phase 180° (t21). Then, from phase 180° to phase 360° (t22), the current direction is reversed and the magnetic charge M decreases to a minimum of about −0.5. After that, the magnetic charge M repeatedly changes from the minimum to the maximum and back, until reaching the end t12 of the ON interval, which also coincides with a phase angle 90° of the oscillator output signal Sv, so that the magnetic charge M finally rises to zero (t12). The magnetic charge M now has an average MAV equal to zero. The absolute value of the minimum and maximum magnetic charge is always lower than in the case of FIG. 3 (this absolute value would be equal to 0.5 in the notation of FIG. 3).

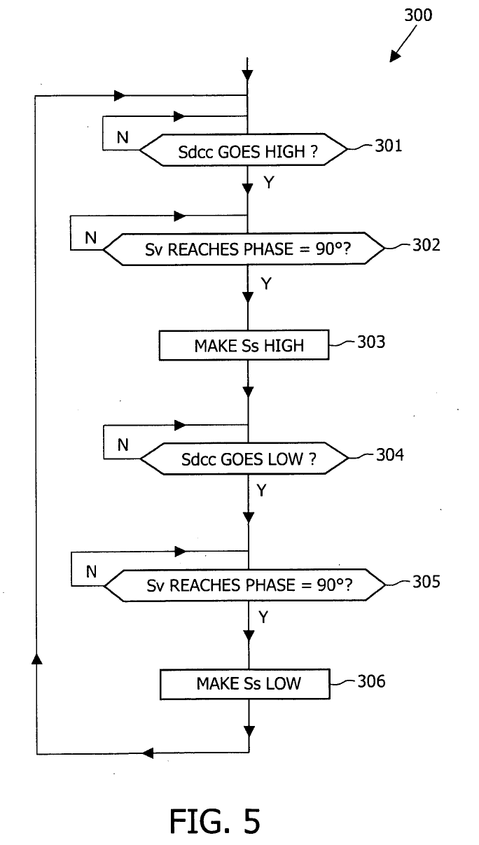

FIG. 5 is a flow diagram illustrating this operation 300 of the lamp driver 1. In a first step 301, the lamp switching controller 20 waits until the dimming command signal Sdcc goes HIGH. In a second step 302, after the dimming command signal Sdcc has gone HIGH, the lamp switching controller 20 waits until the oscillator signal Sv reaches the phase 90°. In a third step 303, at the moment when the oscillator signal Sv reaches the phase 90°, the lamp switching controller 20 makes the switch control signal Ss HIGH in order to make the driven lamp go ON. In a fourth step 304, the lamp switching controller 20 waits until the dimming command signal Sdcc goes LOW. In a fifth step 305, after the duty cycle command signal Sdcc has gone LOW, the lamp switching controller 20 waits until the oscillator signal Sv reaches the phase 90°. In a sixth step 306, at the moment when the oscillator signal Sv reaches the phase 90°, the lamp switching controller 20 makes the switch control signal Ss LOW in order to make the driven lamp go OFF.

It should be clear to a person skilled in the art that the present invention is not limited to the exemplary embodiments discussed above, but that several variations and modifications are possible within the protective scope of the invention as defined in the appending claims.

For instance, instead of the lamp ON interval (t12−t11) being determined by the lamp dimming controller 10, it is also possible that the switch OFF time t12 is determined by the lamp switching controller 20 on the basis of counting HF oscillator pulses.

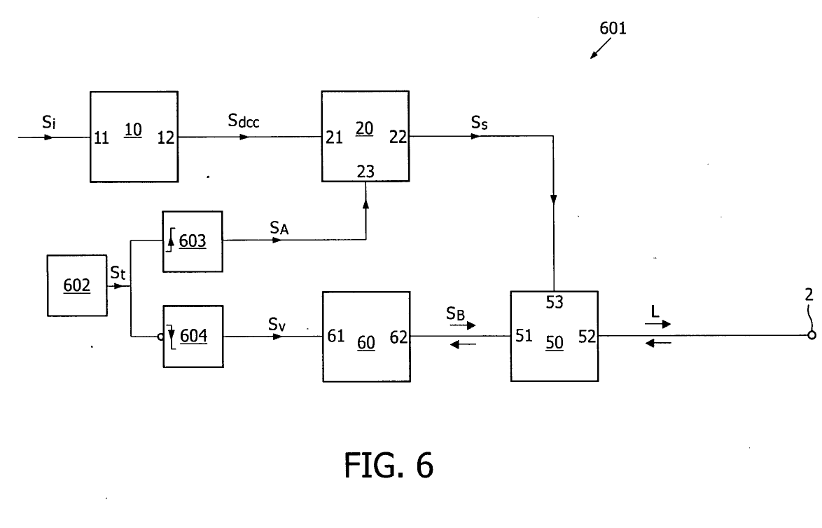

Further, it is possible that the lamp switching controller 20 receives the oscillator signal Sv while the lamp switching controller 20 is provided with a 90° phase shifter for determining the switching times. FIG. 6 illustrates a variation where the driver 601 comprises a master oscillator 602 generating a master oscillator signal St having a duty cycle of 50% and having a frequency twice as high as the oscillator signal Sv. The driver 601 further comprises two frequency dividers 603 and 604, for instance flipflops, changing from HIGH to LOW and vice versa on a specific phase of the master oscillator signal St. The first frequency divider 603 may be triggered by the rising edges of the master oscillator signal St, while the second divider 604 may be triggered by the falling edges of the master oscillator signal St. Thus, while the output signals of the two frequency dividers 603 and 604 exhibit a phase difference of 180° in terms of the master oscillator signal St, they exhibit a phase difference of 90° in terms of their own frequency. The output signal of the second frequency divider 604 may be used as oscillator signal Sv, while the output signal of the first divider 603 may be used as an auxiliary signal Sa to be coupled to the input 23 of the lamp switching controller 20.

In the above, the invention has been explained for the ideal case where the rising edge of the switch control signal Ss coincides with phase 90° of the block-shaped oscillator output signal Sv, with phase=0° being the rising edge of the oscillator output signal Sv. It is noted, however, that the invention already provides an improvement if the rising edge of the switch control signal Ss coincides with a phase (P of the block-shaped oscillator output signal Sv between 0° and 180°.

In the above, the invention has been explained for a case where the switch 50 is conductive when the switch control signal Ss is HIGH and non-conductive when the switch control signal Ss is LOW, but it should be clear that it is also possible that the switch 50 is conductive when the switch control signal Ss is LOW and non-conductive when the switch control signal Ss is HIGH.

In the above, the invention has been explained while referring to the bridge output signal SB as a current signal. It is also possible to refer to the bridge output signal SB as a voltage signal, either passed or blocked by the switch 50, which induces a commutating current in the lamp circuit when passed and results in a zero current in the lamp circuit when blocked.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, digital signal processor, etc.

1. Method for driving a lamp with a periodic signal (L) having a frame period (t13−t11), the periodic signal (L) being a block-shaped signal during an ON-interval (t11 to t12) of said frame period and being zero during an OFF-interval (t12 to t13) of said frame period;
wherein said block-shaped signal has a duty cycle of 50% and a block period (t22−t11) smaller than said frame period;
wherein the duration (t12−t11) of said ON-interval (t11 to t12) of said frame period is equal to an integer number times said block period (t22−t11);
characterized in that the beginning (t11) of said ON-interval (t11 to t12) of said frame period coincides with a phase φ of said block-shaped signal, with 0°<φ<180°.

2. Method according to claim 1, wherein said phase φ is substantially equal to 90°.

3. Method according to claim 1, the method comprising the steps of:
providing a periodic signal that determines a lamp period (t3−t1) and a frame frequency;
generating a high-frequency oscillator signal (Sv);
in a timing relationship with said periodic signal, generating a dimming command signal (Sdcc) determining a target ON time (t1) for the lamp and determining a target OFF time (t2) for the lamp, such that the duty cycle (Δ=(t2−t1)/(t3−t1)) has a desired value;
on the basis of the target ON time (t1), determining an adapted ON time (t11) coinciding with said phase φ of the high-frequency oscillator signal (Sv);
on the basis of the target OFF time (t2), determining an adapted OFF time (t12) coinciding with said phase φ of the high-frequency oscillator signal (Sv);
switching the lamp ON at the adapted ON time (t11) and switching the lamp OFF at the adapted OFF time (t12).

4. Method according to claim 3, wherein the adapted ON time (t11) is determined by the steps of first waiting until the dimming command signal (Sdcc) indicates the target ON time (t1), and then detecting the first subsequent occurrence of the said phase φ of the high-frequency oscillator signal (Sv).

5. Method according to claim 3, wherein the adapted OFF time (t12) is determined by the steps of first waiting until the dimming command signal (Sdcc) indicates the target OFF time (t2), and then detecting the first subsequent occurrence of the said phase φ of the high-frequency oscillator signal (Sv).

6. Method according to claim 3, further comprising the steps of:
in synchronization with said high-frequency oscillator signal (Sv), generating a commutating current signal (L);
blocking the current signal (L) until the adapted ON time (t11);
passing the current signal (L) to a lamp circuit (3) between the adapted ON time (t11) and the adapted OFF time (t12);
blocking the current signal (L) after the adapted OFF time (t12).

7. Method according to claim 1, comprising the steps of:
providing a timer signal (St) having a frequency of twice the frequency of said block-shaped signal;
generating said block-shaped signal (Sv) in synchronization with first type edges of the timer signal (St);
generating an auxiliary signal (Sa) in synchronization with second type edges of the timer signal (St), wherein the second type (rising) is opposite to the first type (falling);
wherein the beginning (t11) of the ON-interval (t11 to t12) of said frame period is determined in synchronization with the auxiliary signal (Sa), and wherein the duration of said ON-interval (t11 to t12) is determined by counting the number of periods of the auxiliary signal (Sa).

8. Lamp driver (1) for driving a lamp, adapted for performing the method of any of the previous claims.

9. Backlighting device for an LCD display device, comprising at least one backlighting lamp and at least one lamp driver (1) according to claim 8.
